(19) United States
(12) Patent Application Publication
(10) Pub. No.: US 2014/0114867 A1
(43) Pub. Date: Apr. 24, 2014

(54) SYSTEM FOR PROVIDING ACTIONS TO REDUCE A CARBON FOOTPRINT

(71) Applicants: Curt Volkmann, Lake Forest, IL (US); David J. Abood, Broadview Heights, OH (US)

(72) Inventors: Curt Volkmann, Lake Forest, IL (US); David J. Abood, Broadview Heights, OH (US)

(73) Assignee: ACCENTURE GLOBAL SERVICES GMBH, Schaffhausen (CH)

(21) Appl. No.: 12/029,949

(22) Filed: Feb. 12, 2008

(51) Int. Cl. G06Q 10/00

(52) U.S. Cl. CPC G06Q 10/30
USPC 705/308

(57) ABSTRACT

A system is described for aiding a user in reducing a carbon footprint. The system includes a processor to process inputted energy use information, where the energy use information is specific to the user. The processor determines an outputted emission data in accordance with the inputted energy use information. A screenshot displays the outputted emission data, wherein the emission data includes a custom action for reducing the carbon footprint.

### TECHNICAL FIELD

The present description relates generally to a system and method, generally referred to as a system, for aiding a user to reduce a carbon footprint.

### BACKGROUND

The United Nations Intergovernmental Panel on Climate Change (IPCC) declared that the warming of the climate system is unequivocal. The warming may be due to an observed increase in greenhouse gas concentrations. Greenhouse gases, which include water vapor, carbon dioxide, methane, nitrous oxide, and ozone, may come from natural sources and human activity. The observed increase in greenhouse gas concentrations may be due, at least in part, to human activity. Companies are banding together to demand U.S. federal action to reduce greenhouse gas concentrations. U.S. governors are developing a multi-state cap-and-trade program. Australia announced a cap-and-trade scheme covering over half the total Australian greenhouse gas emissions.

### SUMMARY

A system is described for providing actions to reduce a carbon footprint of a user. The system includes a processor to process inputted energy use information, where the energy use information is specific to the user. The processor determines an outputted emission data in accordance with the inputted energy use information. A screenshot displays the outputted emission data, wherein the emission data includes a custom action for reducing the carbon footprint.

Other systems, methods, features and advantages will be, or will become, apparent to one with skill in the art upon examination of the following figures and detailed description. It is intended that all such additional systems, methods, features and advantages be included within this description, be within the scope of the embodiments, and be protected by the following claims and be defined by the following claims. Further aspects and advantages are discussed below in conjunction with the description.

### BRIEF DESCRIPTION OF THE DRAWINGS

The system and/or method may be better understood with reference to the following drawings and description. Non-limiting and non-exhaustive descriptions are described with reference to the following drawings. The components in the figures are not necessarily to scale, emphasis instead being placed upon illustrating principles. In the figures, like referenced numerals may refer to like parts throughout the different figures unless otherwise specified.

FIG. 1 is a block diagram of an environment in which the system for providing actions to reduce a carbon footprint may operate.

FIG. 2 is a block diagram of a system for providing actions to reduce a carbon footprint.

FIG. 3 is a block diagram of a general overview of a system for providing actions to reduce a carbon footprint.

FIG. 4 is a flowchart illustrating the operations of the systems of FIG. 2, and FIG. 3, or other systems for providing actions to reduce a carbon footprint.

FIG. 5 is a flowchart illustrating the operations of determining an action to reduce a carbon footprint in the systems of FIG. 2, and FIG. 3, or other systems for providing actions to reduce a carbon footprint.

FIG. 6 is a flowchart illustrating the operations of creating a user profile in the systems of FIG. 2, and FIG. 3, or other systems for providing actions to reduce a carbon footprint.

FIG. 7 is a screenshot of an exemplary output of the systems of FIG. 2 and FIG. 3, or other systems for providing actions to reduce a carbon footprint.

FIG. 8 is a first and second screenshot of an exemplary output of the systems of FIG. 2 and FIG. 3, or other systems for providing actions to reduce a carbon footprint.

FIG. 9 is a screenshot of an exemplary output of the systems of FIG. 2 and FIG. 3, or other systems for providing actions to reduce a carbon footprint.

FIG. 10 is an illustration of a general computer system that may be used in the systems of FIG. 2 and FIG. 3, or other systems for providing actions to reduce a carbon footprint.

### DETAILED DESCRIPTION

A system and method, generally referred to as a system, may relate to aiding a user to reduce a carbon footprint, in which the reduction may be specific to the user. The system is generally an energy demand-side solution to help drive energy efficiency by promoting the use of less energy, the use of more environmentally friendly energy than what is currently being used, and/or promoting use of the energy in ways that differ from the current ways. The system may fit in with other systems offered to help affect the environment in positive ways, such as climate change strategies and roadmaps, supply-side strategies, carbon and financial markets, and energy-related physical infrastructures.

The system may provide energy consumers with customized, actionable information regarding their carbon emissions, such as actual carbon emissions over a variety of sources including electricity, gas, heating oil and coal, and may provide the consumers with recommended actions to reduce carbon emissions. The recommended actions may be prioritized in accordance with a relative impact that an action may have on a unique users' carbon footprint. The reduction of carbon emissions may result in the reduction of energy consumption and cost. The system may be integrated with automation tools to provide users with recommended actions that may be performed automatically.

The system may provide utilities with information regarding their carbon emissions and may provide the utilities with recommended actions to reduce the carbon emissions. The reduction of emissions may enable the utilities to reduce the required number of carbon emission credits, or carbon emission allowances. The utilities may generate additional revenue by trading any surplus credits remaining after reducing their carbon emissions.

The system may provide governments and municipalities with information regarding the emissions of each of the citizens, corporations, or generally any entities under the regulatory control of the government or municipality. The governments may use the system to ensure that government regulations are complied with and/or tax/fine entities for violating carbon emissions regulations.

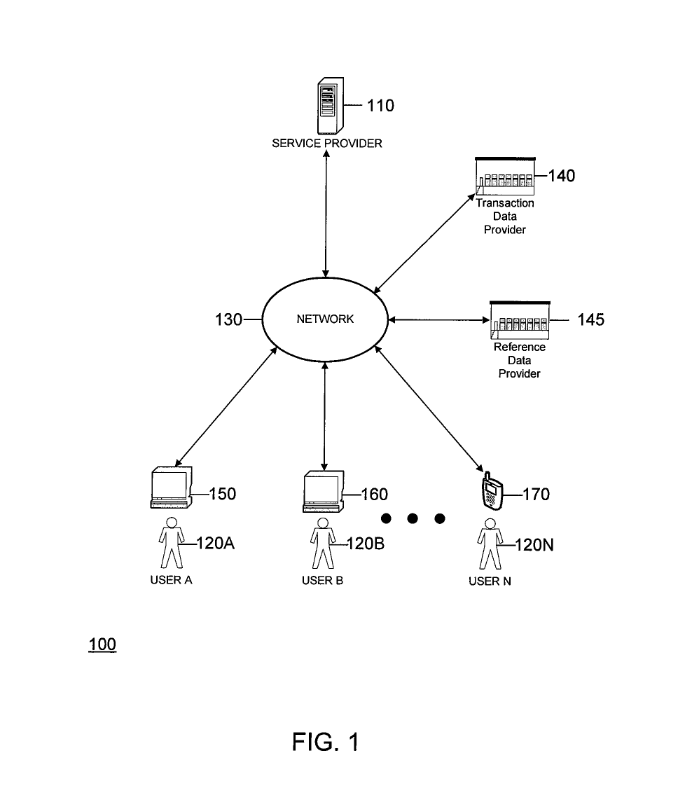

FIG. 1 is a block diagram of an environment 100 in which a system for providing actions to reduce a carbon footprint may operate. Specific information may be giving to a determined user to reduce the carbon footprint for the determined user. Not all of the depicted components may be required, however, and some implementations may include additional components. Variations in the arrangement and type of the components may be made without departing from the spirit or scope of the claims as set forth herein. Additional, different or fewer components may be provided.

The environment 100 includes a service provider 110 connected with user A 120A, user B 120B, user N 120N, etc., via a network 130. The users 120A-N may be individuals, or other entities, such as corporations, governments, educational facilities and/or not-for-profit organizations. The service provider 110 may also connect with information providers such as transaction date providers 140 and reference data providers 145. The transaction data providers 140 include independent system operators (ISO) or others that manage transactions and the flow of a pool of energy. The ISO may determine, such as by calculating and/or estimating, the actual, or approximately actual, sources of energy specific to the users 120A-N. The reference data providers 145 may include entities such as the environmental protection agency (EPA) which provides energy related information, such as information on the energy efficiency of furnaces, the efficiency of insulation, the miles/gallon gas consumption of vehicles, etc. The environment 100 may include web enabled applications 150, mobile applications 160 and/or stand-alone applications 170, or other client applications, to connect the service provider 110 with the users 120A-N and the information providers 140 via the network 130.

The network 130 may include wide area networks (WAN), such as the Internet, local area networks (LAN), campus area networks, metropolitan area networks, or any other networks that may allow for data communication. The network 130 may include all or part of other networks. The network 130 may be divided into sub-networks. The sub-networks may allow access to components connected to the network 130 in the system 100, or the sub-networks may restrict access between the components connected to the networks. The network 130 may be regarded as a public or private network connection and may include, for example, a virtual private network or an encryption or other security mechanism employed over the public Internet, or the like.

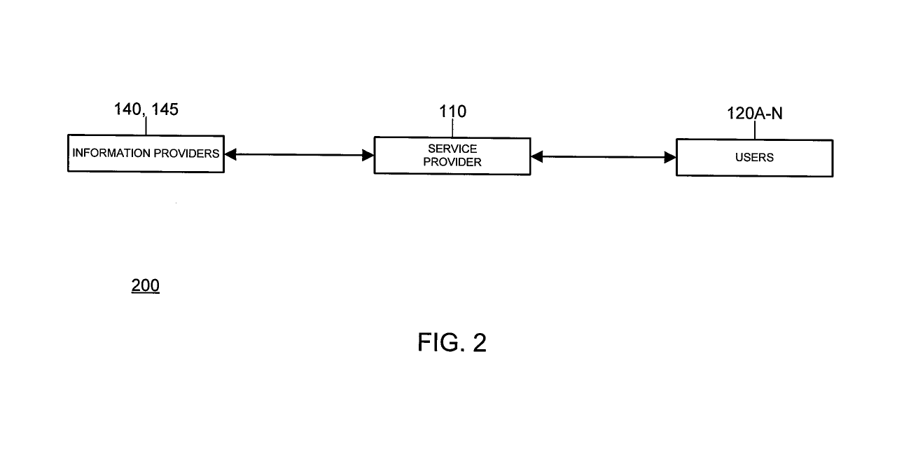

FIG. 2 is a block diagram of a system 200 for providing actions to reduce a carbon footprint. Not all of the depicted components may be required, however, and some implementations may include additional components. Variations in the arrangement and type of the components may be made without departing from the spirit or scope of the claims as set forth herein. Additional, different or fewer components may be provided.

The system 200 may include the service provider 110, energy providers such as information providers 140, and energy consumers such as users 120A-N. The system 200 allows for a service to users 120A-N which provides customized information, analysis and/or advice on action such as to reduce greenhouse gas emissions and to use energy more efficiently than without the system 200. For example, and as described in more detail below, the system 200 may provide users 120A-N with customized, actionable insights to reduce a carbon footprint. Use of the system 200 may result in savings in energy costs. Also, the system 200 may be used to help support and/or verify that regulations, such as from the federal government and/or states, are being complied with.

The system 200 may be provided by a service provider 110, such as consulting firm or other global management consulting, technology services, and/or outsourcing company, such as ACCENTURE LTD. The service provider 110 may collect revenues for providing the service, such as from subscription fees, advertising and/or marketing programs such as an affinity program that enhances brand loyalty by cultivating an ongoing relationship between a marketer and their customer. The service provider 110 may also be compensated by energy providers, such as utilities. In turn, the service providers 110 may help the utilities increase their energy efficiency. By helping the environment, the service provider 110 may also experience an enhanced corporate image and/or employee engagement.

By helping the environment, the information providers 140 may also experience an enhanced corporate image and/or market share. The system 200 may also help the information provider 140 comply with regulations since the system 200 can help with reducing overall greenhouse gas emissions. In some implementations revenue that the service provider 110 collects may be shared with the information provider 140, such as to encourage the information provider to participate in the system 200. The system 200 may also help the information provider 140 accelerate the impact of demand side management (DSM) program by encouraging customers to reduce their electricity consumption. The system 200 may also impact capital expenditures (CAPEX) of the information provider 140 such as by allowing for the deferral of the purchase of new equipment.

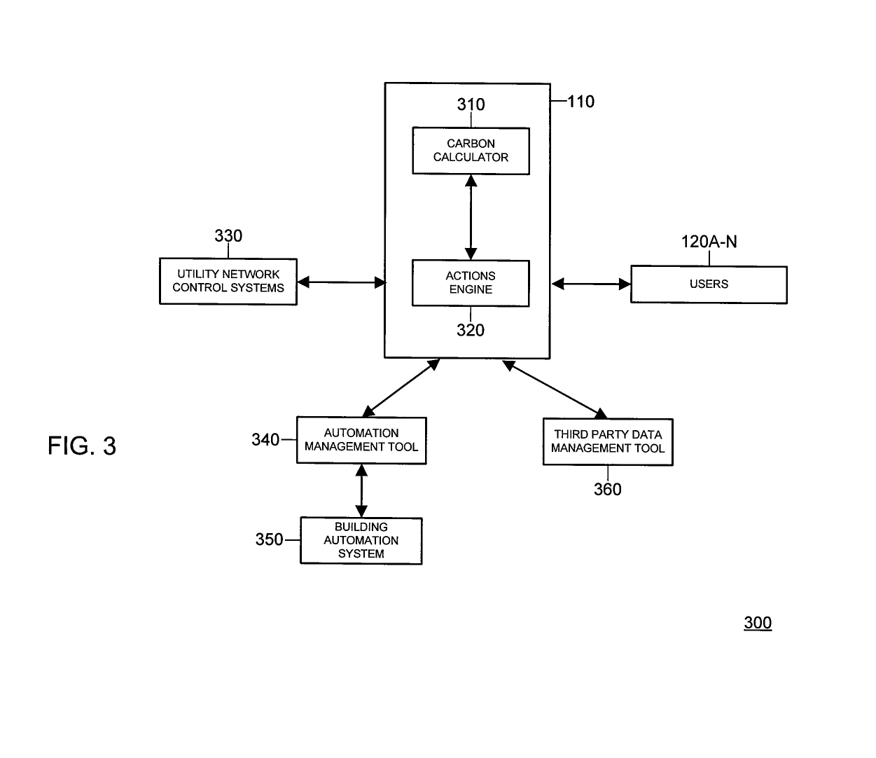

FIG. 3 is a block diagram of a general overview of the system 300 for providing actions to reduce a carbon footprint. Not all of the depicted components may be required, however, and some implementations may include additional components. Variations in the arrangement and type of the components may be made without departing from the spirit or scope of the claims as set forth herein. Additional, different or fewer components may be provided.

The system 300 includes one or more users 120A-N, a service provider 110, one or more information providers such as transaction data providers 140 and/or reference data providers 145, an automation management tool 340 such as by GRIDLOGICS or other automation management tool, a building automation system 350 such as by SMART HOME or other building automation system, and a third party data management tool 360 such as by NEXUS or other data management tool. Applications such as GRIDLOGIX and SMART HOME may be used such that the system 300 automates actions to reduce a carbon footprint of the users 120A-N. For example, if the system 300 determines that the footprint can be reduced by lowering the temperature of a home or commercial site at night to reduce the gas needed to be consumed by a furnace, the system 300 sends instructions to the building automation system 350 which in turn sends instructions to the building automation system 360 to control the lowering of heat at night. The service provider 110 may also provide a carbon calculator 310 and an actions engine 320 to the users 120A-N so that the users 120A-N use the information to manually affect their carbon footprint. Information may also be sent between utility network control systems 330 and the service provider 110.

The users 120A-N may register for a service for providing actions to reduce a carbon footprint provided by the service provider 110. The users 120A-N may provide personal information to the service provider 110, such as name, address, social security number, or generally any information that may be used to obtain energy use data from the utility providers 140. The users 120A-N may manually enter energy use information used to determine a carbon footprint of the users 120A-N. The energy use information may be specific to the user. For example, the users 120A-N may enter information about the square footage of their home, the number of bedrooms, the vehicles they own, the vehicle usage, the types of appliances in the home, the sources of energy to the home, such as electricity, natural gas, propane, coal, solar panels, and any other information. Depending on an implementation, energy use information may also be gathered in other ways, such as directly via the utility providers 140. For example, the utility network control systems 330 may provide an application programming interface (API) to allow the service provider 110 to receive energy use information from the utility providers 140. The service provider 110 may use the information provided by the users 120A-N and/or other sources, for example the transaction data providers 140 and reference data providers 145, to determine energy use and a carbon footprint of the users 120A-N.

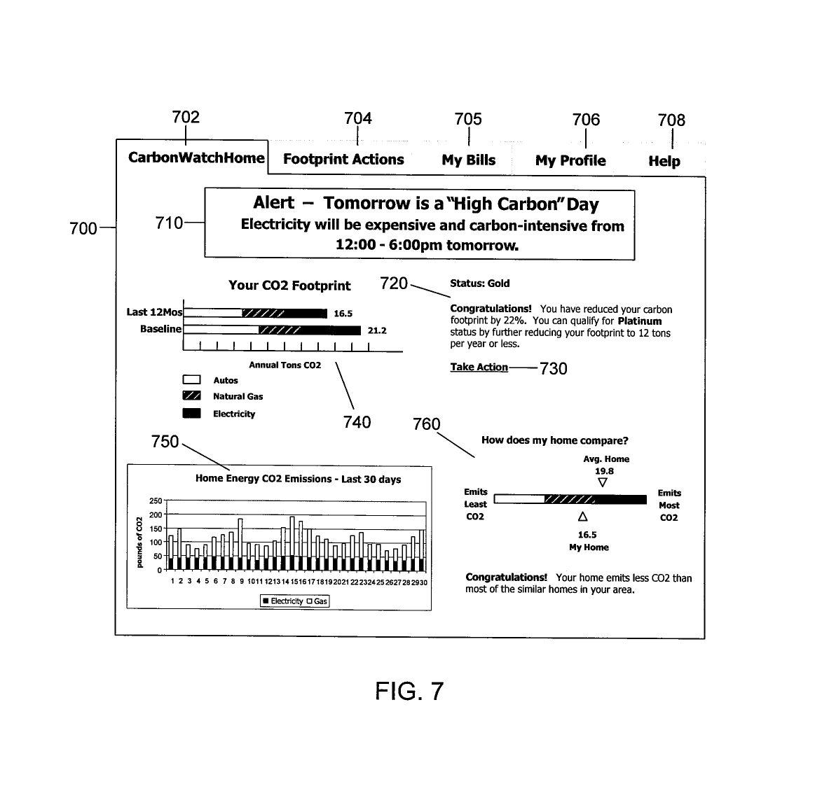

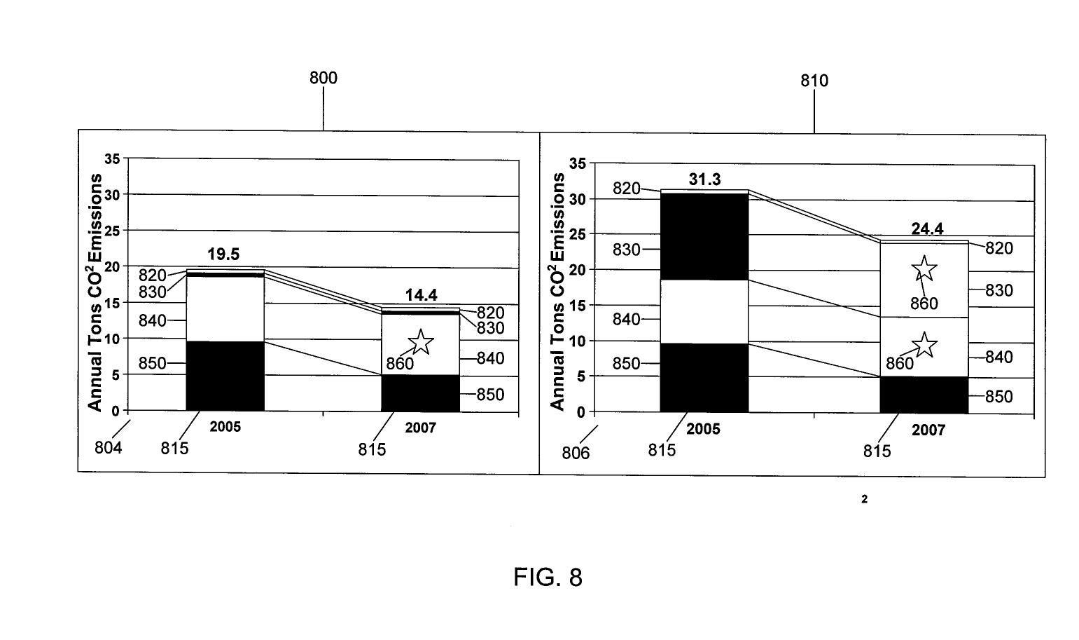

The carbon calculator 310 may process the energy use information provided by the utility providers 140 to generate a carbon footprint of the users 120A-N. The energy use may be displayed to the users 120A-N in a way that aids the users 120A-N in reducing their carbon footprint. The service provider 110 may provide information to the users 120A-N in a way that is sensitive to the particular circumstance of each user. FIGS. 7 and 8 include information that may be displayed to users 120A-N to aid the users in affecting changes, such as to their equipment and behaviors, to help reduce their carbon footprint. The information may be presented to the users 120A-N in a way that helps them prioritize changes based on a relative impact to their carbon footprint (e.g., FIG. 8).

The actions engine 320 may process the carbon footprint to determine one or more actions that may be performed by the users 120A-N to reduce their carbon footprint. The determined actions may depend on the amount of carbon emissions generated by the users 120A-N for each type of energy use, such as electricity, natural gas, propane, heating oil, coal, vehicles, or generally any energy use capable of creating a carbon footprint. In other implementations, the actions engine 320 may compare the carbon emissions of the user A 120A for each energy use against the average carbon emissions of the other users 120B-N. In additional or alternative implementations, the service provider 110 may obtain energy use data from a third party source, such as the third party data management tool 360.

Since the use of a particular type of energy may vary depending upon the geographic location of the users 120A-N, the energy use of the user A 120A may be compared against the energy use of users 120B-N located within the same geographic area as the user A 120A. Alternatively or in addition, the users 120B-N may be located in a geographic area with the same climate as the user A 120A, or within an area where the electric energy providers use the same fuel mix to provide electricity, such as a mix of renewable energy, nuclear energy, natural gas, coal, and/or generally any type of energy capable of producing electricity. The carbon footprint data may also include a trend analysis. The trend analysis may display the historical emissions data of the users 120A-N and may indicate whether the users 120A-N are increasing or decreasing their emissions.

The service provider 110 may communicate the carbon footprint data and the recommended actions to the users 120A-N via the network 130. For example, the carbon footprint data and the recommended actions may be communicated to the users 120A-N via a web page. The carbon footprint data may be represented as a bar graph, a pie chart, or generally any data display capable of conveying the emissions of the users 120A-N. The recommended actions may be presented to the users 120A-N as a list.

The actions engine 320 may recommend some actions to the users 120A-N which may be automatically performed by the service provider 110. In these instances the actions may be presented to the users 120A-N as clickable links, such as links on a web page. The users 120A-N may click on the links to request that the service provider 110 automatically performs the recommended actions. The service provider 110 may perform the recommended actions by interacting with the utility network control systems 330, the automation management tool 340, or generally any component that may automate a carbon reducing action.

The carbon calculator 310 may determine a rating for each of the users 120A-N based on the amount of emissions generated by each of the users 120A-N. The users 120A-N may be eligible for a reward, or other incentives, if they receive a high rating. For example, the carbon calculator 310 may determine the average emissions for users 120A-N within a geographic area. The carbon calculator 310 may then rate the emissions of each of the users 120A-N as they compare to the average emission data. For example, a user A 120A may receive a “bronze” rating if their emissions are at the average, a “silver” rating if their emissions are below the average, a “gold” rating if their emissions are further below the average, and a “platinum” rating if their emissions are far below average. The service provider 110 may provide the users 120A-N with their emissions rating and the reduction in emissions necessary to receive a higher rating.

The automation management tool 340 may be one or more third party software applications, such as software applications provided by GRIDLOGIX, or other application that is used to control residential or commercial facilities. The applications may be used to integrate systems throughout the extended enterprise into a real time management system for energy, maintenance, security and compliance. The automation builder tool 350 may facilitate the users 110A-N in configuring the automation of their energy use which may be used to implement automated recommended actions, such as turning down heating system in the evening.

The third party management tool 310 may be one or more software applications such as software applications provided by NEXUS or other applications which provide a front-end display for providing information to the users 120A-N. An exemplary display is shown in FIG. 7. The third party management tool 310 may provide the service provider 110 and or the users 120A-N, consolidated information regarding the various energy uses of the users 120A-N. The information may be provided to the carbon calculator 310 and/or the actions engine 320. Alternatively or in addition the data may be displayed directly to the users 120A-N.

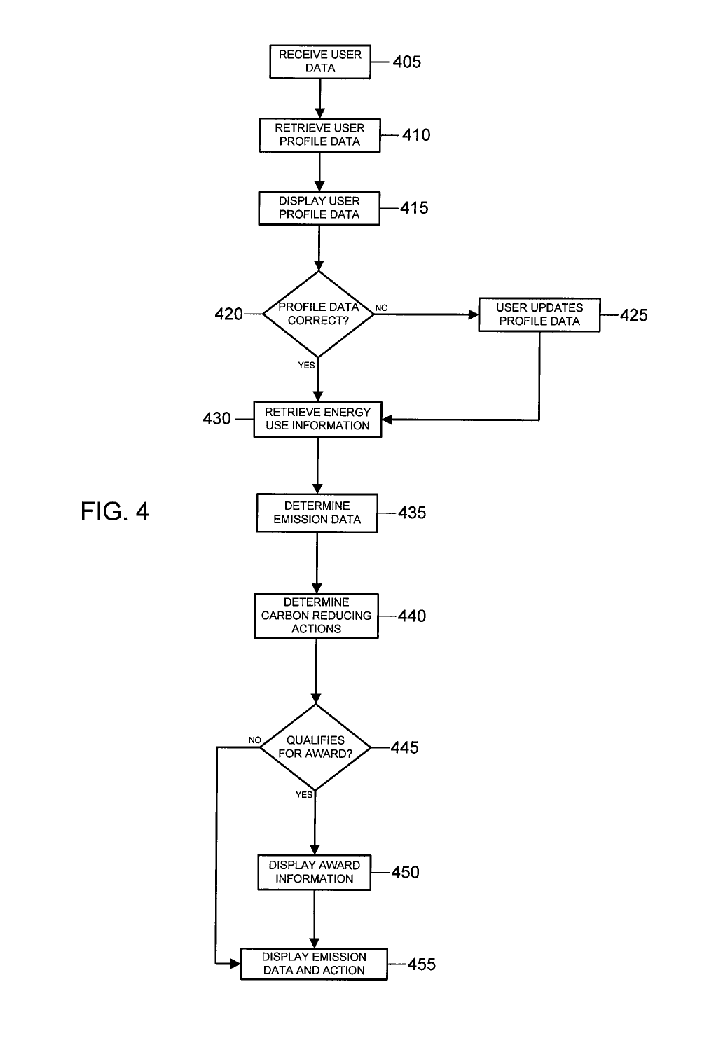

FIG. 4 is a flowchart illustrating the operations of the systems of FIG. 2, and FIG. 3, or other systems for providing actions to reduce a carbon footprint. At block 405 the service provider 110 may receive user data from the user A 120A. The user A 120A may communicate the user data over the network 130, such as by submitting the data on a web page provided by the service provider 110. Alternatively or in addition, the user A 120A may use a telephone and/or paper surveys to communicate the data to the service provider 110. In other implementations, where information may be obtained automatically, the user data may include the name, address, and/or social security number of the user A 120A, and/or generally any information that may be used to retrieve energy use data from information providers, such as transaction data providers 140, utilities, etc.

The user A 120A may enter payment information, such as credit card information, to provide payment to the service provider 110 for the service. Alternatively or in addition, a third party, such as a utility provider 140, may pay the service provider 110 for providing the service to all of the users 120A-N who are customers of the utility provider 140. The service may be included in the utility provided to the users 120A-N, or the users 120A-N may pay an additional fee to the utility provider 140 for the service.

At block 410 the service provider 110 may retrieve the user profile data of the user A 120A from the users 120A-N and/or others such as utility providers 140 and from publicly accessible databases. For example, the service provider 110 may retrieve information regarding the home and vehicle of the user A 120A, natural gas usage, electricity usage, propane, heating oil, coal and/or any additional energy consumption of the user A 120A. The profile data may be stored such that the user's profile as well as subsequent actions that are taken may be remembered to always reflect the most current usage patterns, lifestyle, etc. of the users 120A-N.

In additional and/or alternative implementations, the service provider 110 may retrieve information regarding the size of the home of the user A 120A from a public records database by using the address and/or social security number provided by the user A 120A. Alternatively or in addition the service provider 110 may retrieve the age of the home or generally any other information related to the home that may effect the energy consumption of the user A 120A. The size and age of the home of the user A 120A may be used to compare the emissions of the user A 120A to emissions of users 120B-N with similar homes, and/or may be used to determine recommended actions relevant to the home of the user A 120A. The service provider 110 may request that the user A 120A enter whether they use propane for grilling and/or heating at their home.

The service provider 110 may manually retrieve information on the vehicles owned by the user A 120A from the user A 120A, and/or automatically such as from a publicly accessible vehicle registration database by using the address and/or social security number provided by the user A 120A. The database may provide the number of vehicles owned by the user A 120A, the make/model of the vehicles, and the age of the vehicles. The service provider 110 may use the age of the vehicles to estimate the mileage of the vehicles. The service provider 110 may retrieve from information aggregators such as the reference data providers 145 the estimated miles per gallon (MPG) the vehicles may achieve based on the make/model and age of the vehicle. The original MPG of the vehicle may be accessible via the manufacturer of the vehicle or via a third party database; however the service provider 110 may adjust the MPG to account for the age of the vehicle. The service provider 110 may retrieve the Environmental Protection Agency (EPA) rating of the vehicle, and the carbon emission per mile of the vehicle, from an EPA website, database, or from a third party database.

The service provider 110 may determine the electricity provider of the user A 120A by querying electricity providers in the geographic area of the user A 120A with the social security number and/or address provided by the user A 120A. Alternatively or in addition in geographic areas where only one electricity provider exists the address of the user A 120A may be used to determine the electricity provider. The service provider 110 may retrieve the fuel mix of the electricity provider from the electricity provider or from a third party aggregator of utility fuel mix data.

The service provider 110 may determine the natural gas provider of the user A 120A by querying natural gas providers in the geographic area of the user A 120A with the social security number and/or address provided by the user A 120A. Alternatively or in addition in geographic areas where only one natural gas provider exists the address of the user A 120A may be used to determine the natural gas provider.

At block 415 the service provider 110 may display the collected user profile data to the user A 120A. At block 420, the user A 120A may review the displayed user profile data and determine whether any data is incorrect or missing. For example, the user A 120A may have energy provided by a source that does not have publicly accessible records. If at block 420 the user A 120A indicates that the user profile data is correct, then the system 200 moves to block 430.

If at block 420 the user A 420A indicates that the user profile data is incorrect or missing, the system 200 may move to block 425. At block 425 the user A 120A may correct any incorrect data and/or may enter any missing data. The service provider 110 may provide the user A 120A with an interface, such as a web page, to update any incorrect information and/or to provide specific information regarding any additional energy providers, such as the name, address and telephone number of the energy provider. Once the user A 120A has updated the user profile data the system 200 may move to block 430.

At block 430 the service provider 110 may retrieve the energy use information of the user A 120A. The energy use information may be retrieved directly from the utilities 140, and/or the user A 120A may be required to manually enter energy use information. The utility providers 140 may provide an API to allow the service provider 110 to retrieve the energy use data of the user A 120A. The user A 120A may need to approve of the electricity provider providing usage information to the service provider 110. Alternatively or in addition, if the service provider 110 can not automatically obtain the usage data from the utility providers 140, the service provider 110 may request that the user A 120A enter the energy use information each month. The user A 120A may find the energy use information on their utility statements.

If the user A 120A uses a propane grill or propane heating, the user A 120A may be required to enter an estimate of the propane consumption per month, and/or the service provider 110 may estimate the propane consumption based on the geographic location of the user A 120A, the time of year, or generally any factor that may affect propane consumption. The user A 120A may be requested to estimate the average number of miles per month each vehicle is used. Alternatively or in addition, the service provider 110 may request the user A 120A to enter the mileage of the vehicles each month. The service provider 110 may use the mileage entered each month to determine the actual number of miles each vehicle is used per month. Additionally and/or alternatively, the information may be provided by an ISO or other transaction data provider 140, which may account for the fuels, efficiencies and age of plants supplying power to the users 120A-N.

At block 435 the service provider 435 may determine the emissions data of the user A 120A by processing the energy use information of the user A 120A. The emissions data may be calculated on a periodic basis, such as every month, every week, every day, every hour, or generally any period of time. The service provider 110 may use the fuel mix of the electricity provider and the electricity use of the user A 120A to determine the carbon emissions resulting from electricity use. The carbon emissions resulting from electricity use may be further affected by the actual and/or projected carbon intensity of the electricity, the actual and next day generation dispatch, and the actual and projected carbon dioxide emission density of the electric provider considering the fuel mix. The service provider 110 may use the natural gas use of the user A 120A and the known carbon emissions of natural gas use to determine the carbon emissions as a result of natural gas use. The service provider 110 may use the number of miles each vehicle was used and the carbon emission per mile of the vehicle to determine the carbon emissions of the vehicles. The service provider 110 may use the estimated propane usage of the user A 120A and known carbon emissions of propane usage to determine the carbon emissions as a result of propane use. The service provider 110 may also determine the carbon emissions from any other energy provider of the user A 120A using the energy consumption data and the determined carbon emissions information. The actual and/or projected information for the calculations may be collected from the information providers, such as the transaction data providers 140 and the reference data providers 145.

At block 440 the service provider 110 may determine carbon reducing actions relating to the energy use/emission data of the user A 120A. The actions may be tailored to each user such as based on actual energy uses of the user. The actions may be prioritized in accordance with a relative impact that the action has on a carbon footprint of the user. Actions that provide a greater impact on the carbon footprint may be emphasized. Alternatively and/or additionally, the service provider 110 may compare the emissions data of the user A 120A to the emissions data of the users 120B-N. The set of users 120B-N may be the users 120B-N located in the same geographic region as the user A 120A, the users 120B-N located in a similar climate as the user A 120A, the users 120B-N with similar size/age homes as the user A 120A, or generally any segment of the users 120B-N which may indicate the relative emissions of the user A 120A. The service provider 110 may determine relative emissions of the user A 120A for each energy use type. The service provider 110 may provide recommended actions to the user A 120A geared towards the energy use types where the user A 120A is generating relatively large amounts of carbon emissions.

At block 445 the service provider 110 may determine whether the relative emissions data of the user A 120A qualifies the user A 120A for an award or an incentive. The award or incentive may be sponsored by a corporation, such as WALMART. The corporation may benefit from having an enhanced corporate image and/or market share. Alternatively or in addition the incentives supplied by the corporation may be given in exchange for surplus carbon emissions credits generated by the decrease in emissions of the user A 120A.

If the user A 120A qualifies for an award the system 200 moves to block 450. At block 450 the service provider 110 displays the award information to the user A 120A. If the user A 120A does not qualify for an award, the service provider 110 may display information indicating the reduction in emissions necessary for the user A 120A to qualify for an award and the system 200 may move to block 455.

At block 455 the service provider 110 may display the emission data and the recommended actions to the user A 120A. The emission data may be displayed in a bar graph, a pie chart, or generally any method of displaying the data so as to convey the carbon emissions of the user A 120A. The emissions data of the user A 120A may be compared against users 120B-N with similar energy needs of the user A 120A in order to provide a relative perspective of the energy consumption of the user A 120A.

The relative data may be presented such that the user A 120A may click on one or more characteristics of other users 120B-N to compare emissions data with. For example the characteristics may include home size, geographic location, number of vehicles, age of home, utility providers, or generally any factors which may effect the emissions of the users 120B-N.

The recommended actions may be provided to the user A 120A in a list, such as a list on a web page. The service provider 110 may provide the user A 120A with one or more actions capable of being automatically performed by the service provider 110 in conjunction with the utility providers 140. The user 110 may be provided with the option of selecting one or more automated actions, such as reducing natural gas consumption during the evenings, or reducing electricity consumption during peak energy usage periods. The service provider 110 may also display one or more alerts to the user A 120A regarding factors effecting the near term cost of energy and/or factors affecting the near term emissions of energy.

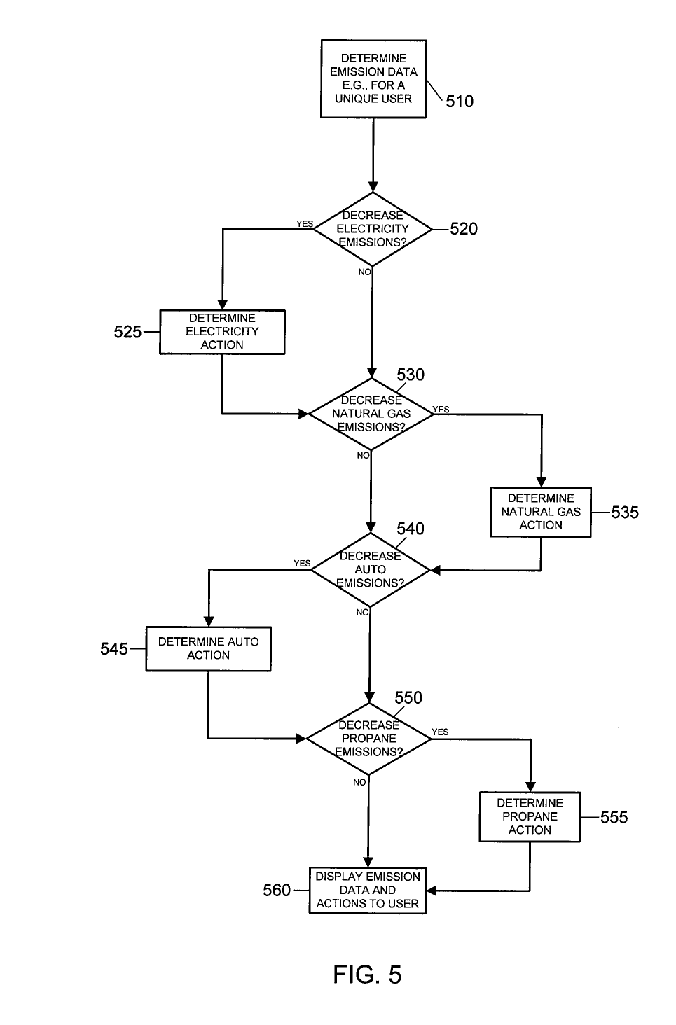

FIG. 5 is a flowchart illustrating the operations of determining an action to reduce a carbon footprint in the systems of FIG. 2, and FIG. 3, or other systems for providing actions to reduce a carbon footprint. At block 510 the service provider 110 determines the emissions data of the user A 120A for each type of emissions generated by the user A 120A, such as electricity emissions, natural gas emissions, automotive emissions, or generally any emissions. Each of the users 120A-N may have a unique carbon footprint, and recommended actions may be tailored in accordance with the unique footprint. Additionally and/or alternatively, the service provider 110 may determine the amount of each type of emission of the additional users 120B-N to determine the relative emissions of the user A 120A.

At block 520 the service provider 110 may determine whether the user A 120A should be recommended actions to reduce their emissions due to electricity usage. If the emissions due to the electricity use of the user A 120A are higher than the emissions due to the electricity use of similar users 120B-N, the system may move to block 525. If the emissions due to the electricity use of the user A 120A are less than or equal to emissions due to the electricity use of similar users 120B-N, the system 200 may move to block 530.

At block 525 the service provider 110 may determine a carbon reducing action related to electricity use. For example, the service provider 110 may recommend that the user A 120A replace energy consuming appliances, such as a washer/dryer, with more efficient appliances. Alternatively or in addition, the service provider 110 may recommend the user A 120A unplug unneeded appliances, such as a third refrigerator.

At block 530 the service provider 110 may determine whether the user A 120A should be recommended actions to reduce their carbon emissions due to natural gas use. If the emissions due to the natural gas use of the user A 120A are higher than the emissions due to natural gas use of similar users 120B-N, the system may move to block 535. If the emissions due to the natural gas use of the user A 120A are less than the emissions due to natural gas use of similar users 120B-N, the system 200 may move to block 540.

At block 535 the service provider 110 may determine a carbon reducing action related to natural gas use. For example, the service provider 110 may recommend that the user A 120A add insulation to their home. If the user A 120A has an older home, the service provider 110 may recommend replacing the windows of the home with newer windows which may be better at insulating heat. Alternatively or in addition the service provider 130 may recommend that the user A 120A reduce their natural gas use in the evening, such as by turning down their heating systems. If the user A 120A has configured home automation the service provider 110 may provide the user A 120A with an option to have the service provider 110 automatically reduce the natural gas consumption of the user in the evening.

At block 540 the service provider 110 may determine whether the user A 120A should be recommended actions to reduce their carbon emissions due to automobile use. If the emissions due to the automobile use of the user A 120A are higher than the emissions due to automobile use of similar users 120B-N, the system may move to block 545. If the emissions due to the automobile use of the user A 120A are less than emissions due to automobile use of similar users 120B-N, the system 200 may move to block 550.

At block 545 the service provider 110 may determine a carbon reducing action related to automobile use. For example, the service provider 110 may recommend that the user A 120A replace their vehicles with hybrid vehicles. Alternatively or in addition, the service provider 110 may utilize publicly accessible databases to recommend public transportation options to the user A 120A.

At block 550 the service provider 110 may determine whether the user A 120A should be recommended actions to reduce their carbon emissions due to propane use. If the emissions due to the propane use of the user A 120A are higher than the emissions due to propane use of similar users 120B-N, the system may move to block 545. If the emissions due to the propane use of the user A 120A are less than the emissions due to the propane use of similar users 120B-N, the system 200 may move to block 550.

At block 555 the service provider 110 may determine a carbon reducing action related to propane use. For example, the service provider 110 may recommend that the user A 120A to replace a furnace with a ground source heat pump. Alternatively and/or additionally, the service provider 110 may recommend that the user A 120A turn off their propane grill immediately after use. Alternatively or in addition the service provider 110 may recommend the user A 120A utilize an alternate energy source for grilling, such as solar cells.

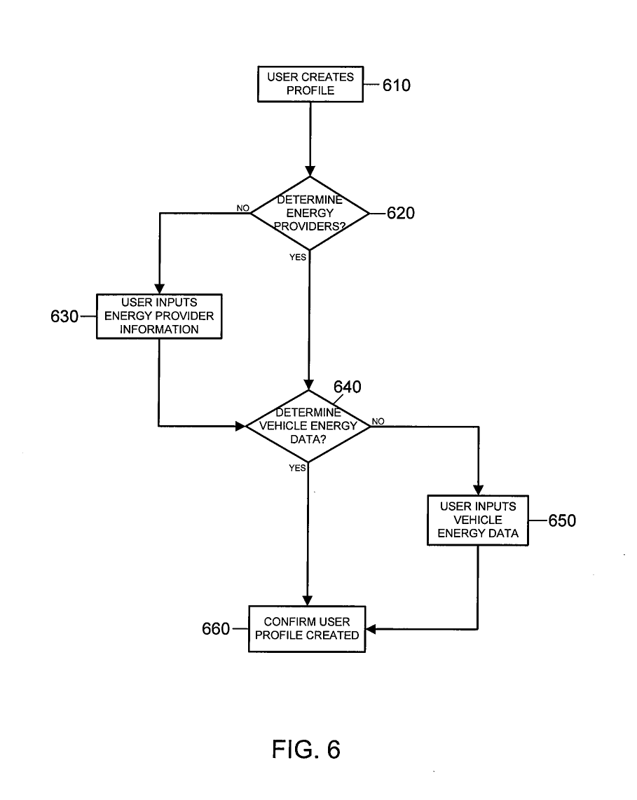

FIG. 6 is a flowchart illustrating the operations of creating a user profile in the systems of FIG. 2, and FIG. 3, or other systems for providing actions to reduce a carbon footprint. At block 610 the user A 120A creates a user profile by providing personal information, such as name, address, social security number, or generally any information which may be used to determine the emissions data of the user A 120A. A block 620 the service provider 110 attempts to access publicly available databases to determine the natural gas and electricity providers of the user A 120A.

The service provider 110 may determine the natural gas and electricity providers of the user A 120A by querying the user A 120A. Alternatively and/or additionally, the service provider 110 may attempt to automatically obtain the information from utility providers 140 in the geographic area of the user A 120A with the social security number and/or address provided by the user A 120A. Alternatively or in addition, in geographic areas where only one provider exists for each utility, the address of the user A 120A may be used to determine the utility providers 140. If the service provider 110 is able to determine the natural gas and energy providers the system 200 moves to block 640. If the service provider 110 is unable to determine the natural gas and energy providers the system 200 moves to block 630.

At block 630 the user A 120A may enter information describing their natural gas provider, electricity provider, and/or any additional energy providers. The service provider 110 may provide an interface, such as a web page, to the user A 120A to enable the user A 120A to entering the energy provider information.

At block 640 the service provider 110 may attempt to determine the vehicle data and vehicle emissions data of the user A 120A by utilizing publicly accessible databases, such as of reference data providers 145. The service provider 110 may retrieve the personal auto usage from a publicly accessible vehicle registration database by using the address and/or social security number provided by the user A 120A. The database may provide the number of vehicles owned by the user A 120A, the make/model of the vehicles, and the age of the vehicles. The service provider 110 may use the age of the vehicles to estimate the mileage of the vehicles. The service provider 110 may retrieve the original MPG of the vehicle from the manufacturer. The service provider 110 may determine an MPG the vehicles may achieve based on the make/model and age of the vehicle. The service provider 110 may retrieve the Environmental Protection Agency (EPA) rating of the vehicle, and the carbon emission per mile of the vehicle, from an EPA website, database, or from a third party database. If the service provider 110 is able to determine the automobile emissions information of the user A 120A, the system 200 may move to block 660. If the service provider 110 is unable to determine the automobile emissions information the system 200 may move to block 650.

At block 650 the user A 120A may enter information describing their vehicles, such as the make/model of the vehicles, the age of the vehicles, and/or the mileage of the vehicles. The service provider 110 may provide an interface, such as a web page, to the user A 120A for entering the automobile information.

At block 660 the service provider 110 may display the collected information to the user A 120A. The service provider 110 may request that the user A 120A confirm that the information is correct, update any incorrect information, and/or add any missing information.

FIG. 7 is a screenshot 700 of an exemplary output of the systems of FIG. 2 and FIG. 3, or other systems for providing actions to reduce a carbon footprint. The screenshot 700 includes a home tab 702, an action tab 704, a bills tab 705, a profile tab 706, a help tab 708, an alert box 710, a status message 720, an action link 730, a footprint graph 740, a emissions graph 750 and a comparison graph 760. The service provider 100 may provide the output displayed in the screenshot 700 to the user A 120A via the network 130, such as on a web page.

The user A 120A may click on the tabs 702, 704, 705, 706, 708 to access different screens. If the user A 120A clicks on the home tab 702 the screenshot 700 may display the home screen, as shown in the screenshot 700. If the user A 120A clicks on the actions tab 704 the screenshot 700 may display the actions screen. The actions screen may include one or more recommended actions geared towards reducing the emissions of the user A 120A. If the user A 120A clicks on the bills tab 705 the screenshot 700 may display the current energy bills of the user A 120A, such as natural gas bills, electricity bills, or generally any energy bills. The service provider 110 may receive the bill information from the utility network control systems 330 via the network 130. The user A 120A may be able to pay one or more energy bills via the bills tab 705. If the user A 120A clicks on the profile tab 706 the screenshot 700 may display a profile screen showing the current profile of the user A 120A. The profile screen may display the actual kilowatt hours and thermal usage of the user A 120A as provided by the electricity and gas providers, and the actual EPA fuel efficiency for the vehicles of the user A 120A. The profile screen may also display the actual and projected carbon dioxide emission density of the electric provider considering the fuel mix. The user A 120A may be able to update the profile via the profile screen, such as by adding a new vehicle to the profile. If the user A 120A clicks on the help tab 708 the screenshot 700 may display the help screen. The help screen may provide the user A 120A with information regarding the use of the screens.

The alert box 710 may display a current energy alert which may affect the user A 120A. The service provider 110 may determine energy alerts or may receive energy alerts from third parties, such as the utility providers 140. The status message 720 may display the current status of the emissions of the user A 120A. The status message 720 may display a tier that the relative emissions of the user A 120A falls within and may display a message describing the amount of emissions the user A 120A needs to reduce to reach the next tier. The status message 720 may also indicate whether the user A 120A is eligible for an award. The user A 120A may click on the action link 730 to reach the actions screen.

The footprint graph 740 may display the tons of carbon emissions of the user A 120A over the past twelve months along with the initial carbon emissions of the user A 120A. Alternatively or in addition the footprint graph 740 may display the carbon emission of the user A 120A over any determined period of time. The footprint graph 740 may break down the emissions data based on the type of energy use which generated the emissions, such as electricity, natural gas, and/or automotive.

The emissions graph 750 may display the emissions due to home energy consumption, such as natural gas and electricity, over a determined period of time, such as the last thirty days. The emissions graph 750 may provide the user A 120A with information regarding particular days when their emissions were higher than others, such as weekends.

The comparison graph 760 may display the relative emissions of the user A 120A due to home energy use. The comparison graph 760 may display the emissions resulting from the home energy use of the user A 120A and the emissions resulting from the home energy use in the average home. The user A 120A may be able to click on one or more checkboxes to compare their energy consumption against homes with one or more similar characteristics. For example, the user A 120A may compare their home against homes of similar age, size, geographic location, and/or generally any characteristic capable of affecting the amount of emissions resulting from home energy use.

FIG. 8 is a first screenshot 800 and a second screenshot 810 of an exemplary output of the system 200. The service provider 110 may display one of the screenshot 800, 810 to the user A 120A alternatively or in addition to the screenshot 700. The screenshot 900 may provide the user A 120A with additional information regarding their carbon emissions.

The first and second screenshots 800, 810 display bar graphs 804, 806 showing the annual tons of carbon dioxide on one axis and a year on the other axis. The graphs 804, 806 are exemplary such that other time periods and elements can be used, such as monthly greenhouse gas emissions for determined months. Also, displays other than bar graphs, such as pie charts, may be used. In this example, graph 804 displays a carbon footprint for a four thousand square-foot home in northern Illinois and graph 806 displays a carbon footprint for a four thousand square-foot home in central Ohio. In other examples, the graph 804 may be based on other types and/or sizes of facilities, including commercial facilities, and/or for other locations throughout the world.

In this example, from 2005 to 2007, actions taken to reduce the carbon footprint include replacing two purely gasoline powered cars with hybrids and converting one car to a plug-in electric vehicle (PEV). Other actions taken were to replace twenty-five incandescent light sources with more energy efficient compact fluorescent lights (CFL). A washer/dryer was replaced with high efficiency models, a third refrigerator was unplugged and insulation was added to the house. Based on these actions, the system 200 uses the graphs 804, 806 to display that the carbon dioxide emissions produced by the household were reduced from 19.5 in 2005 to 14.4 in 2007. The bars 815 of the bar graphs 804, 806 may be divided into sections, such as by sources of carbon dioxide, including propane 820, electricity 830, natural gas 840 and vehicles 850 such as personal automobiles. An indicator 860, such as a star symbol, notifies that user of an area where further action may be best taken to further reduce a carbon footprint. The indicator 860 may be used to provide a sensitivity analysis such that the indicator 860 can be placed in areas that have the biggest relative impact on a carbon footprint for a particular user at a specific point in time.

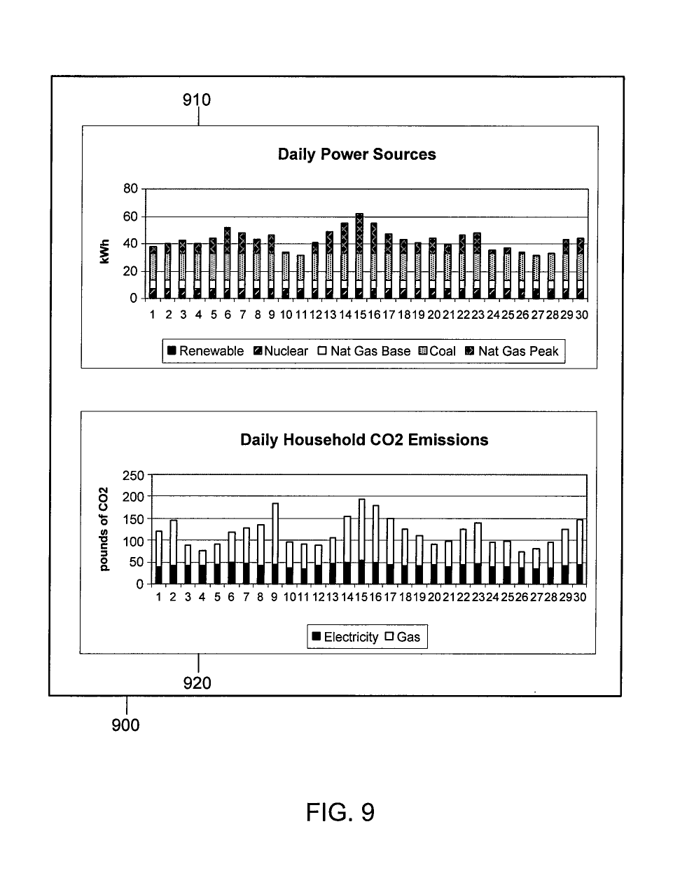

FIG. 9 is a screenshot 900 of an exemplary output of the systems of FIG. 2 and FIG. 3, or other systems for providing actions to reduce a carbon footprint. The service provider 110 may display the screenshot 900 to the user A 120A alternatively or in addition to the screenshot 700. The screenshot 900 may provide the user A 120A with additional information regarding their carbon emissions.

The screenshot 900 displays a daily power sources graph 910 and a daily emissions graph 920. The daily power sources graph 910 may display the power sources used to provide the user A 120A with home energy over a period of time, such as thirty days. The daily emissions graph 920 may display the daily household emissions over a period of time, such as thirty days. The user A 120A may view the graphs 910, 920 together to view the daily changes in the fuel mix of dispatched generation and the effect of the changes in the fuel mix on their emissions.

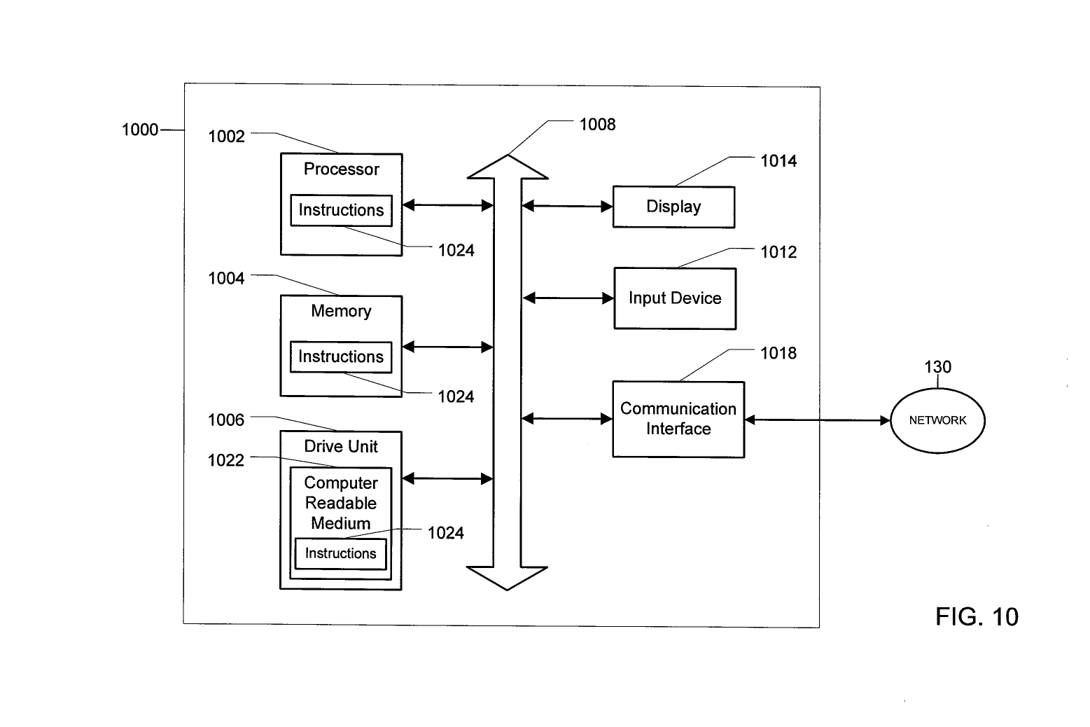

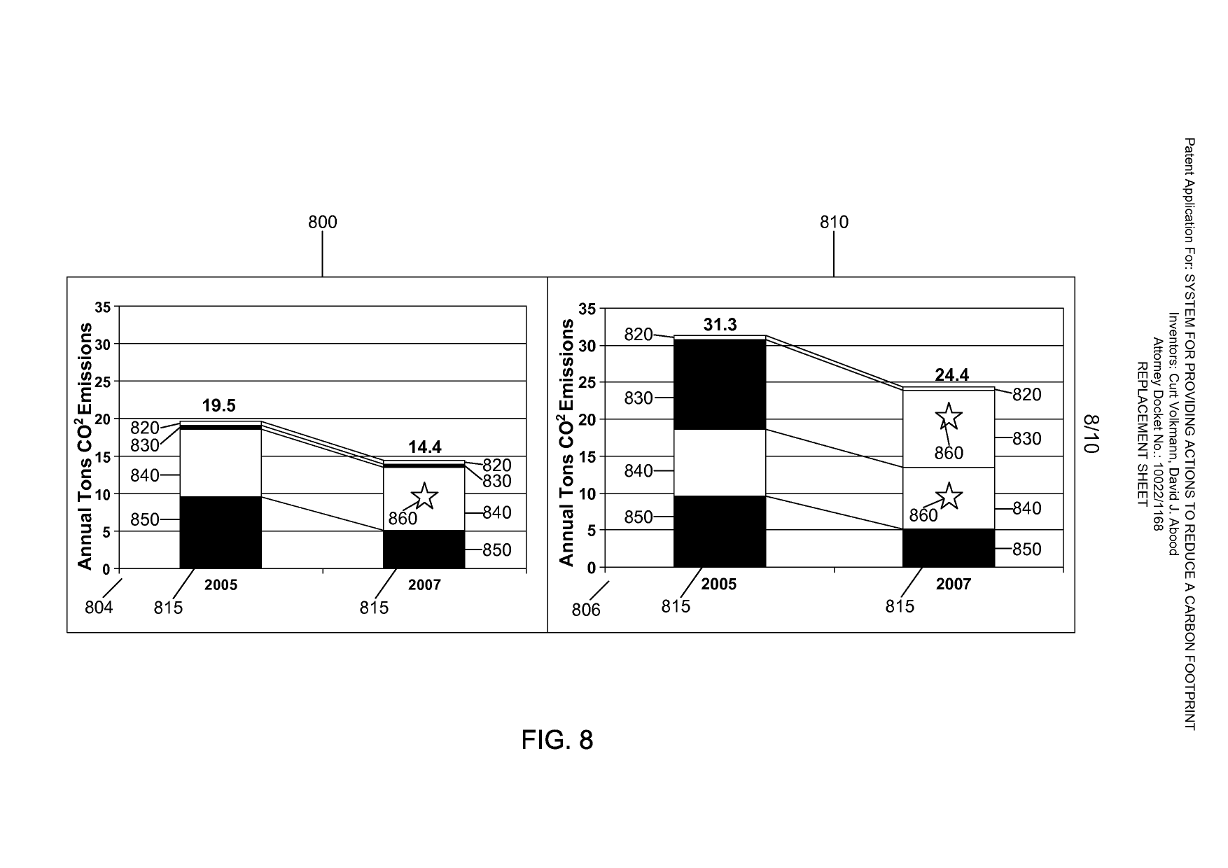

FIG. 10 illustrates a general computer system 1000, which may represent a carbon calculator 310, an actions engine 320, a utility network control system 330, or any of the other computing devices referenced herein. Not all of the depicted components may be required, however, and some implementations may include additional components not shown in the figure. Variations in the arrangement and type of the components may be made without departing from the spirit or scope of the claims as set forth herein. Additional, different or fewer components may be provided.

The computer system 1000 may include a set of instructions 1024 that may be executed to cause the computer system 1000 to perform any one or more of the methods or computer based functions disclosed herein. The computer system 1000 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 1000 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions 1024 (sequential or otherwise) that specify actions to be taken by that machine. In a particular embodiment, the computer system 1000 may be implemented using electronic devices that provide voice, video or data communication. Further, while a single computer system 1000 may be illustrated, the term “system” shall also be taken to include any collection of systems or sub-systems that individually or jointly execute a set, or multiple sets, of instructions to perform one or more computer functions.

In FIG. 10, the computer system 1000 may include a processor 1002, such as, a central processing unit (CPU), a graphics processing unit (GPU), or both. The processor 1002 may be a component in a variety of systems. For example, the processor 1002 may be part of a standard personal computer or a workstation. The processor 1002 may be one or more general processors, digital signal processors, application specific integrated circuits, field programmable gate arrays, servers, networks, digital circuits, analog circuits, combinations thereof, or other now known or later developed devices for analyzing and processing data. The processor 1002 may implement a software program, such as code generated manually (i.e., programmed).

The computer system 1000 may include a memory 1004 that can communicate via a bus 1008. The memory 1004 may be a main memory, a static memory, or a dynamic memory. The memory 1004 may include, but may not be limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one case, the memory 1004 may include a cache or random access memory for the processor 1002. Alternatively or in addition, the memory 1004 may be separate from the processor 1002, such as a cache memory of a processor, the system memory, or other memory. The memory 1004 may be an external storage device or database for storing data. Examples may include a hard drive, compact disc (“CD”), digital video disc (“DVD”), memory card, memory stick, floppy disc, universal serial bus (“USB”) memory device, or any other device operative to store data. The memory 1004 may be operable to store instructions 1024 executable by the processor 1002. The functions, acts or tasks illustrated in the figures or described herein may be performed by the programmed processor 1002 executing the instructions 1024 stored in the memory 1004. The functions, acts or tasks may be independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

The computer system 1000 may further include a display 1014, such as a liquid crystal display (LCD), an organic light emitting diode (OLED), a flat panel display, a solid state display, a cathode ray tube (CRT), a projector, a printer or other now known or later developed display device for outputting determined information. The display 1014 may act as an interface for the user to see the functioning of the processor 1002, or specifically as an interface with the software stored in the memory 1004 or in the drive unit 1006.

Additionally, the computer system 1000 may include an input device 1012 configured to allow a user to interact with any of the components of system 1000. The input device 1012 may be a number pad, a keyboard, or a cursor control device, such as a mouse, or a joystick, touch screen display, remote control or any other device operative to interact with the system 1000.

The computer system 1000 may also include a disk or optical drive unit 1006. The disk drive unit 1006 may include a computer-readable medium 1022 in which one or more sets of instructions 1024, e.g. software, can be embedded. Further, the instructions 1024 may perform one or more of the methods or logic as described herein. The instructions 1024 may reside completely, or at least partially, within the memory 1004 and/or within the processor 1002 during execution by the computer system 1000. The memory 1004 and the processor 1002 also may include computer-readable media as discussed above.

The present disclosure contemplates a computer-readable medium 1022 that includes instructions 1024 or receives and executes instructions 1024 responsive to a propagated signal; so that a device connected to a network 130 may communicate voice, video, audio, images or any other data over the network 130. Further, the instructions 1024 may be transmitted or received over the network 130 via a communication interface 1018. The communication interface 1018 may be a part of the processor 1002 or may be a separate component. The communication interface 1018 may be created in software or may be a physical connection in hardware. The communication interface 1018 may be configured to connect with a network 130, external media, the display 1014, or any other components in system 1000, or combinations thereof. The connection with the network 130 may be a physical connection, such as a wired Ethernet connection or may be established wirelessly as discussed below. Likewise, the additional connections with other components of the system 1000 may be physical connections or may be established wirelessly.

The network 130 may include wired networks, wireless networks, or combinations thereof. The wireless network may be a cellular telephone network, an 802.11, 802.16, 802.20, or WiMax network. Further, the network 130 may be a public network, such as the Internet, a private network, such as an intranet, or combinations thereof, and may utilize a variety of networking protocols now available or later developed including, but not limited to TCP/IP based networking protocols.

The computer-readable medium 1022 may be a single medium, or the computer-readable medium 1022 may be a single medium or multiple media, such as a centralized or distributed database, and/or associated caches and servers that store one or more sets of instructions. The term “computer-readable medium” may also include any medium that may be capable of storing, encoding or carrying a set of instructions for execution by a processor or that may cause a computer system to perform any one or more of the methods or operations disclosed herein.

The computer-readable medium 1022 may include a solid-state memory such as a memory card or other package that houses one or more non-volatile read-only memories. The computer-readable medium 1022 also may be a random access memory or other volatile re-writable memory. Additionally, the computer-readable medium 1022 may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that may be a tangible storage medium. Accordingly, the disclosure may be considered to include any one or more of a computer-readable medium or a distribution medium and other equivalents and successor media, in which data or instructions may be stored.

Alternatively or in addition, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system may encompass software, firmware, and hardware implementations.

The methods described herein may be implemented by software programs executable by a computer system. Further, implementations may include distributed processing, component/object distributed processing, and parallel processing. Alternatively or in addition, virtual computer system processing maybe constructed to implement one or more of the methods or functionality as described herein.

Although components and functions are described that may be implemented in particular embodiments with reference to particular standards and protocols, the components and functions are not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations described herein are intended to provide a general understanding of the structure of various embodiments. The illustrations are not intended to serve as a complete description of all of the elements and features of apparatus, processors, and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the description. Thus, to the maximum extent allowed by law, the scope is to be determined by the broadest permissible interpretation of the following claims and their equivalents, and shall not be restricted or limited by the foregoing detailed description.

1. A method for reducing a carbon footprint of a user, comprising:
inputting, into a service provider, energy use information specific to the user;
processing the energy use information in the service provider to determine a plurality of specific actions for the user to perform to reduce the carbon footprint of the user;
outputting emission data in accordance with the processed energy use information, wherein outputting the emission data includes displaying, to the user, a list of the plurality of specific actions for reducing the carbon footprint of the user;
determining whether the plurality of specific actions comprise automatable actions;
facilitating, in the service provider, the automatic performance of the automatable actions for the user.

2. The method of claim 1 wherein the energy use information comprises gas information, electricity information, home energy information and vehicle information.

3. The method of claim 1 wherein the output emission data is dependent on a time of day.

4. The method of claim 1 wherein the output emission data is dependent on a geographical location of the user.

5. The method of claim 1 wherein the output emission data is dependent on a supplier of electricity to the user.

6. The method of claim 1 wherein the emission data is output as a bar graph of total carbon dioxide emissions over time.

7. The method of claim 6 wherein the bar of the bar graph is separated into sources of carbon dioxide.

8. The method of claim 7 wherein the sources include propane, electricity, natural gas, heating oil, coal and vehicles.

9. The method of claim 7 wherein the bar graph includes an indicator of where to focus actions for carbon footprint reductions.

10. The method of claim 9 wherein the indicator comprises a symbol located on the bar of the bar graph.

11. A system for aiding a user in reducing a carbon footprint, the system comprising:
a processor configured to process inputted energy use information, wherein the energy use information is specific to the user, the processor to determine a plurality of specific actions for the user to perform to reduce the carbon footprint of the user;
a screenshot to display the outputted emission data, wherein the screenshot includes a list of custom actions for reducing the carbon footprint,
wherein the processor is further configured to determine whether the plurality of specific actions comprise automatable actions, and to facilitate the automatic performance of the automatable actions for the user.

12. The system of claim 11 wherein the screenshot displays the emission data as a bar graph of total carbon dioxide emissions over time.

13. The system of claim 12 wherein the bar of the bar graph is separated into sources of carbon dioxide.

14. The system of claim 13 wherein the sources include propane, electricity, natural gas, heating oil, coal and vehicles.

15. The system of claim 11 wherein the bar graph includes an indicator of where to focus actions for carbon footprint reductions.

16. The system of claim 15 wherein the indicator comprises a symbol located on the bar of the bar graph.

17. The system of claim 11 wherein the screenshot displays a graph that illustrates the carbon footprint of the user over a time period versus a baseline.

18. The system of claim 17 wherein the graph illustrates the carbon footprint for vehicle, natural gas and electricity usage.

19. The system of claim 11 wherein the screenshot displays alert for high carbon time periods.

20. The system of claim 11 wherein the screenshot displays awards for reducing the carbon footprint over time by a determined amount.

21. The system of claim 11 wherein the screenshot displays a sliding bar graph that indicates a carbon footprint of the user versus an average carbon footprint.

22. The system of claim 11 wherein the energy use information comprises gas information, electricity information, home energy information and vehicle information.

23. The system of claim 11 wherein the output emission data is dependent on a time of day.

24. The system of claim 11 wherein the output emission data is dependent on a geographical location.

25. The system of claim 11 wherein the output emission data is dependent on a supplier of electricity to the user.

26. The method of claim 1, wherein facilitating, in the service provider, the automatic performance of the automatable actions for the user comprises:
interacting with a utility network control system corresponding to the user; and
automatically configuring the utility network control system to implement the automatable actions.

27. The method of claim 11, wherein the processor is configured to facilitate the automatic performance of the automatable actions for the user by:
interacting with a utility network control system corresponding to the user; and
automatically configuring the utility network control system to implement the automatable actions.

28. The method of claim 1, wherein outputting emission data in accordance with the processed energy use information comprises:
prioritizing the list of plurality of specific actions for reducing the carbon footprint of the user based on a relative impact on the carbon footprint of the user; and
presenting the prioritized plurality of specific actions to the user in a user interface.

29. The method of claim 1, wherein outputting emission data in accordance with the processed energy use information comprises:
performing trend analysis on the energy use information specific to the user to determine historical emissions data of the user; and
displaying the historical emissions data of the user.

30. The method of claim 1, wherein processing the energy use information comprises:
determining a rating for the user based on an amount of emissions generated by the user and compared to an average emission data of other users within a geographic area.
